(19) United States
(12) Patent Application Publication
(10) Pub. No.: US 2013/0045677 A1
(43) Pub. Date: Feb. 21, 2013

(54) Telematics System and Related Mobile Device and Method

(71) Applicant: Ho-Sung Chien, Taoyuan County (TW)

(72) Inventor: Ho-Sung Chien, Taoyuan County (TW)

(21) Appl. No.: 13/587,919

(22) Filed: Aug. 16, 2012

Related U.S. Application Data
(60) Provisional application No. 61/524,329, filed on Aug. 17, 2011.

(51) Int. Cl. H04B 7/00

(52) U.S. Cl. 455/39

(57) ABSTRACT

A method of interaction for a mobile device in a telematics system is disclosed. The method includes the steps of establishing connections with a plurality of vehicle head-units and processing a plurality of interaction streams with the plurality of vehicle head-units independently.

### CROSS REFERENCE TO RELATED APPLICATIONS

This application claims the benefit of U.S. Provisional Application No. 61/524,329, filed on Aug. 17, 2011 and entitled “Method for Interacting the Mobile Device with Multiple Head-Units in Telematics System”, the contents of which are incorporated herein in their entirety.

### BACKGROUND OF THE INVENTION

1. Field of the Invention

The present invention relates to a telematics system and related mobile device and method, and more particularly, to a telematics system and related mobile device and method which allow a mobile device to process interaction streams with multiple vehicle head-units simultaneously.

2. Description of the Prior Art

Telematics is the combination of information and communications technology to send, receive and store information via telecommunications devices. In recent years, telematics is applied in in-vehicle environment for drivers to read vehicle's information such as speed and location, listen to radio, receive news updates, and so on. Said telematics for in-vehicle environment is realized by an in-vehicle telecommunications device called as vehicle head-unit. A vehicle head-unit can be integrated with a mobile device in a telematics system, such that one can control the mobile device remotely by operating the vehicle head-unit.

Consumer Electronics for Automotive (CE4A) is one of the major organizations focusing on telematics standards of mobile device interfaces. While CE4A members are only German car companies, Car Connectivity Consortium (CCC) launched in 2011 has various kinds of member companies (e.g. car companies, on-board unit (OBU) manufacturers and mobile phone companies). The first version (v1.0) of CCC technical specification inherits from CE4A.

In the CCC Mirror Link Core Architecture specification, the Mirror Link provides a concept for integrating the mobile device (as Mirror Link Server) and the vehicle head-unit (as Mirror Link Client). In a Mirror Link context, the control and interaction of applications and services running on the mobile device will be replicated into a vehicle environment. The vehicle head-unit may contain a display, a speaker, a microphone and a user input interface, such that the vehicle head-unit can play video/audio profiles provided by the mobile device, controlling the UI of the mobile device, making or accepting a call via the mobile device, and so on. The interaction stream is exchanged between the mobile device and the vehicle head-unit, which may include diverting display and audio streaming from the mobile device to the vehicle head-unit come together with receiving key and voice control input from the vehicle head-unit to the mobile device.

Nowadays there may be more than one vehicle head-unit in a vehicle. However, there is no flow or description in the prior art (e.g. CCC Mirror Link specification) to specify how the mobile device interacts with more than one vehicle head-unit. When there is more than one vehicle head-unit interacting with the same mobile device, the mobile device will fail to process interaction streams since the interaction streams corresponding to different vehicle head-units could be processed simultaneously.

### SUMMARY OF THE INVENTION

It is therefore a primary objective of the present invention to provide a telematics system and related mobile device and method which allow a mobile device to process interaction streams with multiple vehicle head-units simultaneously.

The present invention discloses a method of interaction for a mobile device in a telematics system. The method includes the steps of: establishing connections with a plurality of vehicle head-units; and processing a plurality of interaction streams with the plurality of vehicle head-units independently.

The present invention further discloses a mobile device for a telematics system. The mobile device includes a communication interfacing unit, a processing means, a storage unit and a program code. The communication interfacing unit is utilized for connecting with a plurality of vehicle head-units in the telematics system. The program code, which is stored in the storage unit, instructs the processing means to execute the following steps: establishing connections with the plurality of vehicle head-units via the communication interfacing unit; and processing a plurality of interaction streams with the plurality of vehicle head-units independently.

The present invention further discloses a telematics system including a plurality of vehicle head-units and a mobile device. The mobile device includes a communication interfacing unit, a processing means, a storage unit and a program code. The communication interfacing unit is utilized for connecting with the plurality of vehicle head-units. The program code, which is stored in the storage unit, instructs the processing means to execute the following steps: establishing connections with the plurality of vehicle head-units via the communication interfacing unit; and processing a plurality of interaction streams with the plurality of vehicle head-units independently.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a telematics system according to an example of the present invention.

FIG. 2 is a schematic diagram of a communication device according to an example of the present invention.

FIG. 3 is a flowchart diagram of an interaction process according to an example of the present invention.

FIG. 4 is a schematic diagram of a telematics system according to another example of the present invention.

### DETAILED DESCRIPTION

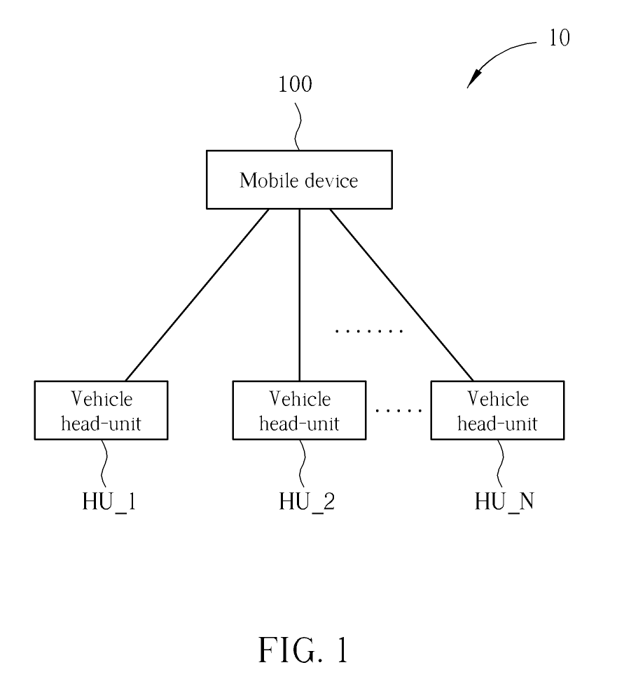

Please refer to FIG. 1, which is a schematic diagram of a telematics system 10 according to an example of the present invention. The telematics system 10 supports Mirror Link Core Architecture Specification developed by Car Connectivity Consortium (CCC), and includes a mobile device 100 and vehicle head-units HU_1-HU_N. Preferably, the telematics system 10 is in an in-vehicle environment. The mobile device 100 can be any device such as mobile phone, laptop, tablet computer, electronic book and portable computer system, and is capable of performing interaction with the vehicle head-units HU_1-HU_N. In general, the mobile device 100 has an application to process interactions with the vehicle head-units HU_1-HU_N. The mobile device 100 may connect with the vehicle head-units HU_1-HU_N via any wired/wireless connection technologies including, but not limited to, universal serial bus (USB), IEEE 1394, wireless fidelity (WiFi), Bluetooth and general packet radio service (CPRS).

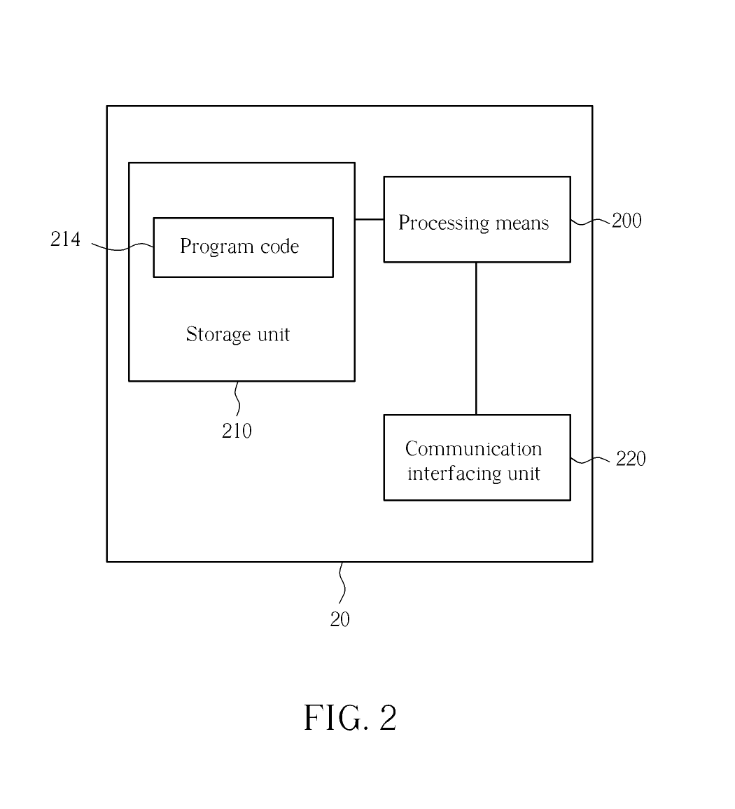

Please refer to FIG. 2, which is a schematic diagram of a communication device 20 according to an example of the present invention. The communication device 20 may be implementation of the mobile device 100 or the vehicle head-units HU_1-HU_N. The communication device 20 may include a processing means 200 such as a microprocessor or an Application Specific Integrated Circuit (ASIC), a storage unit 210 and a communication interfacing unit 220. The storage unit 210 maybe any data storage device that can store a program code 214, and can be accessed by the processing means 200. Examples of the storage unit 210 include but are not limited to a subscriber identity module (SIM), read-only memory (ROM), flash memory, random-access memory (RAM), CD-ROM/DVD-ROM, magnetic tape, hard disk, and optical data storage device. The communication interfacing unit 220 may be a radio transceiver, a Bluetooth transceiver, a WiFi transceiver, an IEEE 1394 interface or a USB interface, and can transmit/receive a message according to processing results of the processing means 200.

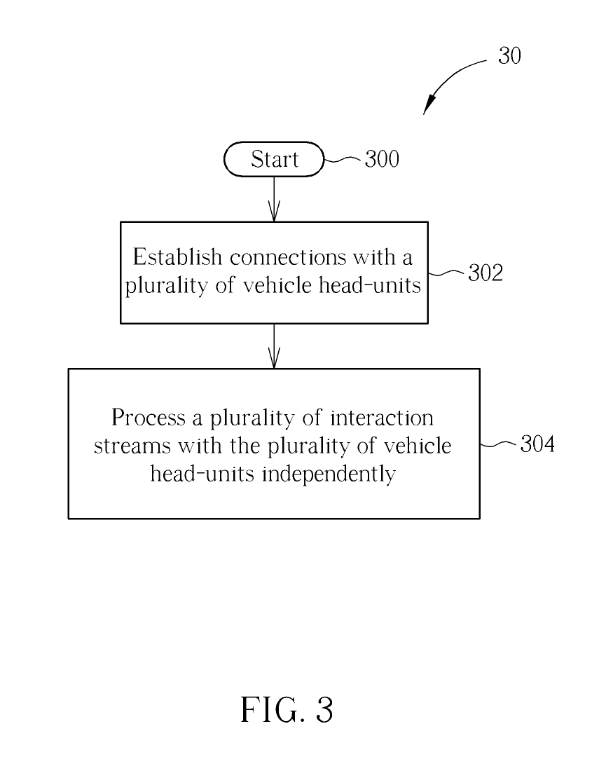

Please refer to FIG. 3, which is a flowchart diagram of an interaction process 30 according to an example of the present invention. The interaction process 30 is utilized in the mobile device 100 shown in FIG. 1, for handling interaction with the vehicle head-units HU_1-HU_N. The interaction process 30 maybe compiled into the program code 214 and includes the following steps:

Step 300: Start.

Step 302: Establish connections with a plurality of vehicle head-units.

Step 304: Process a plurality of interaction streams with the plurality of vehicle head-units independently.

According to the interaction process 30, when the mobile device 100 enters into an in-vehicle environment where the vehicle head-units HU_1-HU_N are present, the mobile device 100 establishes connections with the vehicle head-units HU_1-HU_N. Then, the mobile device 100 processes interaction streams with vehicle head-units HU_1-HU_N independently, i.e., one interaction stream is processed without being interfered by another interaction stream. In other words, a first operation to the mobile device 100 (via the vehicle head-unit HU_1) is not interfered by a second operation to the mobile device 100 (via the vehicle head-unit HU_2).

In one example of Step 304, the mobile device 100 processes a first interaction stream with a first vehicle head-unit (e.g. HU_1) and a second interaction stream with a second vehicle head-unit (e.g. HU_2). In operation, the mobile device 100 may process an interaction stream with the vehicle head-unit HU_1 first. During the interaction between the mobile device 100 and the vehicle head-unit HU_1, the mobile device 100 may also start processing another interaction stream between the mobile device 100 and the vehicle head-unit HU_2 without interference, such that the mobile device 100 performs interactions with the vehicle head-units HU_1 and HU_2 independently.

For example, the mobile device 100 can have a first process which provides a screen projecting on the vehicle head-unit HU_1 and processes the first interaction stream to and from the vehicle head-unit HU_1, and can also have a second process which provides a screen projecting on the vehicle head-unit HU_2 and processes the second interaction stream to and from the vehicle head-unit HU_2.

In another example, the mobile device 100 can project all or part of its screen to the vehicle head-unit HU_1, while at the same time an input signal of the vehicle head-unit HU_2 (e.g. input signal generated when a user touches a button on the vehicle head-unit HU_2) can be transferred to the mobile device 100.

The interaction streams between the mobile device 100 and the vehicle head-units HU_1-HU_N can be uni-directional or bi-directional. For example, the mobile device 100 can transmit/receive bi-directional transmissions to/from the vehicle head-unit HU_1 for playing audio file on vehicle head-unit HU_1 or on the mobile device 100, and the mobile device 100 can also be controlled by the vehicle head-unit HU_2 performing uni-directional transmission.

In addition, the mobile device 100 has the ability of initiating disconnections with some or all of the vehicle head-units HU_1-HU_N in certain conditions, e.g. when the mobile device 100 is turning off.

Please note that, the aforementioned steps of the process including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 20.

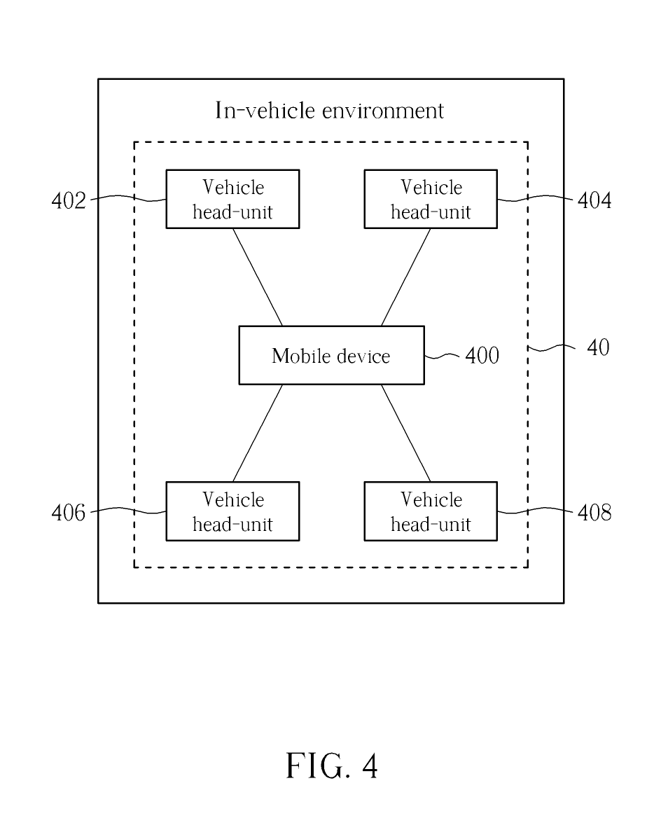

The telematics system of the present invention maybe applied for various in-vehicle environments. Please refer to FIG. 4, which is a schematic diagram of a telematics system 40 according to another example of the present invention. The telematics system 40 exists in a common in-vehicle environment. There are one mobile device 400 and four vehicle head-units 402, 404, 406, 408 in the telematics system 40. The vehicle head-units 402, 404, 406, 408 are located at the four areas of the in-vehicle environment. The mobile device 400 may transmit the same streaming video/audio to the vehicle head-units 402, 404, 406, 408 for people using the vehicle head-units 402, 404, 406, 408 to watch the same media file. Alternatively, the mobile device 400 may transmit different streaming videos/audios to the vehicle head-units 402, 404, 406, 408 for playing different media files, according to people's demands. In addition, the vehicle head-unit 402, which is located at the driver's area, may transmit vehicle's information, such as level of fuel contained, real-time fuel consumption, blind-spot detection system configuration, in-vehicle temperature, cruise control information, speed of the vehicle, etc., to the mobile device 400.

To sum up, the telematics system and related mobile device and method according to the examples of the present invention allow a mobile device to process interaction streams with multiple vehicle head-units simultaneously, so as to improve convenience of usage in an in-vehicle environment.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of interaction for a mobile device in a telematics system, comprising the steps of:
establishing connections with a plurality of vehicle head-units; and
processing a plurality of interaction streams with the plurality of vehicle head-units independently.

2. The method of claim 1, wherein the step of processing the plurality of interaction streams comprises processing a first interaction stream of the plurality of interaction streams with a first vehicle head-unit of the plurality of vehicle head-units and a second interaction stream of the plurality of interaction streams with a second vehicle head-unit of the plurality of vehicle head-units independently.

3. The method of claim 1, further comprising:
initiating disconnections with the plurality of vehicle head-units.

4. A mobile device for a telematics system, comprising:
a communication interfacing unit, for connecting with a plurality of vehicle head-units in the telematics system;
a processing means;
a storage unit; and
a program code stored in the storage unit;
wherein the program code instructs the processing means to execute the following steps:
establishing connections with the plurality of vehicle head-units via the communication interfacing unit; and
processing a plurality of interaction streams with the plurality of vehicle head-units independently.

5. The mobile device of claim 4, wherein the step of processing the plurality of interaction streams comprises processing a first interaction stream of the plurality of interaction streams with a first vehicle head-unit of the plurality of vehicle head-units and a second interaction stream of the plurality of interaction streams with a second vehicle head-unit of the plurality of vehicle head-units independently.

6. The mobile device of claim 4, further comprising:
initiating disconnections with the plurality of vehicle head-units.

7. A telematics system, comprising:
a plurality of vehicle head-units; and
a mobile device, comprising:
a communication interfacing unit, for connecting with the plurality of vehicle head-units;
a processing means;
a storage unit; and
a program code stored in the storage unit;
wherein the program code instructs the processing means to execute the following steps:
establishing connections with the plurality of vehicle head-units via the communication interfacing unit; and
processing a plurality of interaction streams with the plurality of vehicle head-units independently.

8. The system of claim 7, wherein the step of processing a plurality of interaction streams comprises processing a first interaction stream of the plurality of interaction streams with a first vehicle head-unit of the plurality of vehicle head-units and a second interaction stream of the plurality of interaction streams with a second vehicle head-unit of the plurality of vehicle head-units independently.

9. The system of claim 7, further comprising:
initiating disconnections with the plurality of vehicle head-units.
